(19) United States
(12) Patent Application Publication
(10) Pub. No.: US 2023/0012158 A1
(43) Pub. Date: Jan. 12, 2023

(54) INTERLACING SCAN PATTERNS TO ENHANCE REGIONS OF INTEREST

(71) Applicant: Seagate Technology LLC, Fremont, CA (US)

(72) Inventors: Daniel Joseph Klemme, Robbinsdale, MN (US); Kevin A. Gomez, Eden Prairie, MN (US); Daniel Aaron Mohr, Saint Paul, MN (US)

(21) Appl. No.: 17/863,026

(22) Filed: Jul. 12, 2022

Related U.S. Application Data
(60) Provisional application No. 63/220,634, filed on Jul. 12, 2021.

(51) Int. Cl. G01S 17/89; G01S 7/481; G01S 7/483; G01S 17/931; G02B 26/08

(52) U.S. Cl. CPC G01S 17/89; G01S 7/4817; G01S 7/483; G01S 17/931; G02B 26/08

(57) ABSTRACT

Apparatus and method for enhancing resolution in a light detection and ranging (LiDAR) system. In some embodiments, an emitter is configured to emit a first beam of light pulses over a baseline, first field of view (FoV). Responsive to an activation signal, a controller circuit directs the emitter to concurrently interleave a second beam of light pulses over a second FoV within the first FoV. The first and second beams may be provided at different resolutions and frame rates, and may have pulses with different waveform characteristics to enable decoding using separate detection channels. The interlaced beams provide variable scanning of particular areas of interest within the baseline FoV. The second beam may be activated based on range information obtained from the first beam, or from an external sensor. Separate light sources operative at different wavelengths can be used to generate the first and second beams.

### RELATED APPLICATION

The present application makes a claim of domestic priority to U.S. Provisional Patent Application No. 63/220,634 filed Jul. 12, 2021, the contents of which are hereby incorporated by reference.

### SUMMARY

Various embodiments of the present disclosure are generally directed to an apparatus and method for enhanced scanning techniques in an active light detection system.

Without limitation, some embodiments provide an emitter which emits a first beam of light pulses over a baseline, first field of view (FoV). Responsive to an activation signal, a controller circuit directs the emitter to concurrently emit a second beam of light pulses over a second FoV within the first FoV. The first and second beams may be provided at different resolutions and frame rates, and may have pulses with different waveform characteristics to enable decoding using separate detection channels. The interlaced beams provide variable scanning of particular areas of interest within the baseline FoV. The second beam may be activated based on range information obtained from the first beam, or based on other information provided from an external sensor. Different light sources with different characteristics, such as different wavelengths, may be used to generate the respective first and second beams.

These and other features and advantages of various embodiments can be understood in view of the following detailed description in conjunction with the accompanying drawings.

### BRIEF DESCRIPTION OF THE DRAWINGS

FIG. 1 is a block representation of a data handling system constructed and operated in accordance with various embodiments of the present disclosure.

FIG. 2 shows an emitter of the system in some embodiments.

FIGS. 3A and 3B show different types of output systems that can be used by various embodiments.

FIG. 4 shows a detector of the system in some embodiments.

FIG. 5 illustrates an interleaved scanning aspect of the emitter in some embodiments.

FIG. 6 shows the emitter of FIG. 5 using multiple output devices in some embodiments.

FIG. 7 is a scanning response diagram to illustrate operation of the system of FIG. 6 in some embodiments.

FIG. 8 is another scanning response diagram from use of the system of FIG. 6 in some embodiments.

FIG. 9 shows use of different detection channels in some embodiments.

FIG. 10 provides a timing sequence diagram to illustrate operation in accordance with some embodiments.

FIG. 11 is an interleaved scan sequence to illustrate operations carried out in accordance with various embodiments.

FIG. 12 shows an adaptive foveation management system in accordance with further embodiments.

### DETAILED DESCRIPTION

Various embodiments of the present disclosure are generally directed to optimization of an active light detection system through the use of interlaced scan patterns.

Light Detection and Ranging (LiDAR) systems are useful in a number of applications in which ranges (e.g., distances) from an emitter to a target are detected by irradiating the target with electromagnetic radiation in the form of light. The range information is detected in relation to timing characteristics of reflected light received back by the system. LiDAR applications include topographical mapping, guidance, surveying, and so on. One increasingly popular application for LiDAR is in the area of autonomously piloted or driver assisted vehicle guidance systems (e.g., self-driving cars, autonomous drones, etc.). While not limiting, the light wavelengths used in a typical LiDAR system may range from ultraviolet to near infrared (e.g., 250 nanometers, nm to 1550 nm or more). Other wavelength ranges can be used.

One commonly employed form of LiDAR is sometimes referred to as coherent pulsed LiDAR, which generally uses coherent light and detects the range information based on detecting phase differences in the reflected light. Such systems may use a dual (IQ) channel detector with an I (in-phase) channel and a Q (quadrature) channel. Other forms of LiDAR systems can be used, however, including non-coherent light systems that may incorporate one or more detection channels. Further alternatives that can be incorporated into LiDAR systems include systems that sweep the emitted light using mechanical based systems that utilize moveable mechanical elements, solid-state systems with no moving mechanical parts but instead use phase array mechanisms to sweep the emitted light in a direction toward the target, and so on.

Various embodiments of the present disclosure are directed to a method and apparatus for generating light beams in a LiDAR system to provide enhanced resolution of a downrange environment. As explained below, some embodiments implement foveation of a field of view (FoV) by interleaving (interlacing) scan patterns with a novel scanning architecture such that multiple frame rates can be used with constant increase or reduction in point resolution. In this context, foveation will be generally understood as the operation to provide different resolution areas, including with different point densities, within the FoV.

Some embodiments utilize multiple beam sources (e.g., multiple lasers) to provide the interleaved scan patterns. Other embodiments utilize two or more output systems that partially or fully overlap the FoV, so that one output system is used for full-frame scanning while one or more of the remaining output systems are used to provide variable span, variable velocity (down to zero) position control modes, etc.

Any number of output systems can be used to direct the respective interlaced scan patterns, including galvonometers (galvos), refractive lenses, mirrors, prisms, micromirrors, rotatable polygons, solid-state arrays, etc. The scans can be rasterized along one or more orthogonal directions (e.g., x and y directions, etc.). While not limiting, in some cases one beam can be scanned in a first direction (e.g., x-axis) and a second beam can be scanned in an orthogonal second direction (e.g., y-axis).

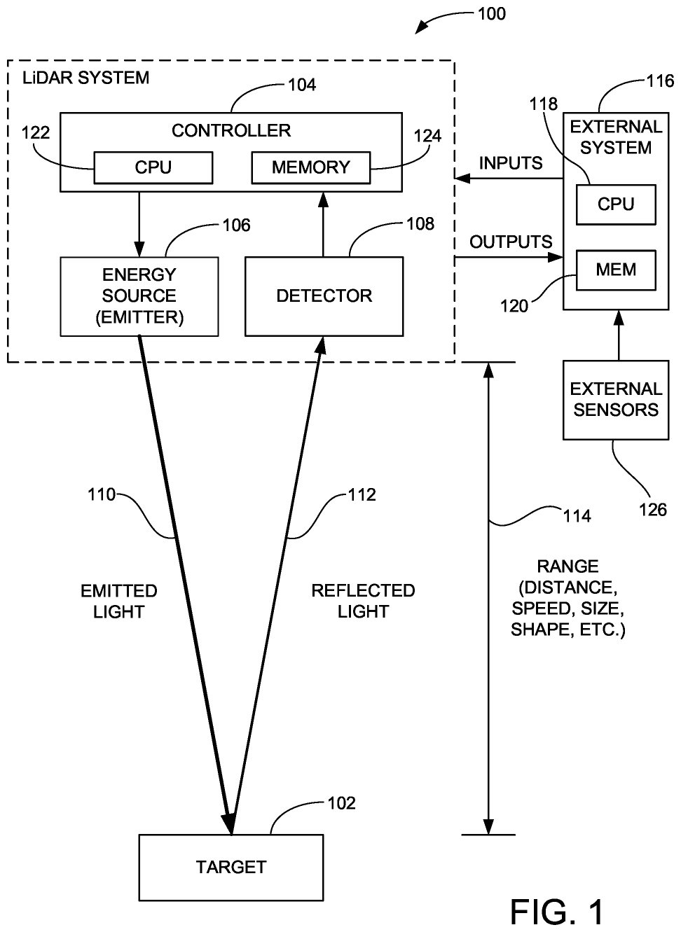

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

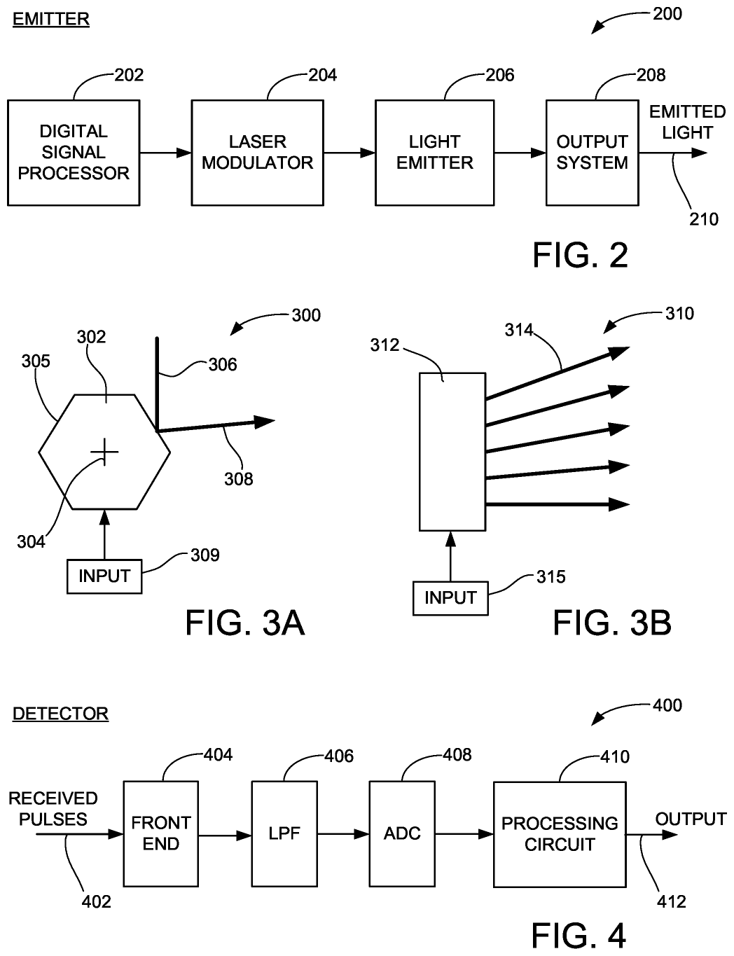

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter (e.g., a laser, a laser diode, etc.) that emits electromagnetic radiation (e.g. light) in a desired spectrum. The emitted light is processed by an output system 208 to issue a beam of emitted light 210. The light may be in the form of pulses, coherent light, non-coherent light, swept light, etc.

FIGS. 3A and 3B show different aspects of some forms of output systems that can be used by the system of FIG. 2. Other arrangements can be used. FIG. 3A shows a system 300 that includes a rotatable polygon 302 which is mechanically rotated about a central axis 304 at a desired rotational rate. The polygon 302 has reflective outer surfaces 305 adapted to direct incident light 306 as a reflected stream 308 at a selected angle responsive to the rotational orientation of the polygon 302. The polygon is characterized as a hexagon with six reflective sides, but any number of different configurations can be used. By coordinating the impingement of light 306 and rotational angle of the polygon 302, the output light 308 can be swept across a desired field of view (FoV). An input system 309, such as a closed loop servo system, can control the rotation of the polygon 302.

FIG. 3B provides a system 310 with a solid state array (integrated circuit device) 312 configured to emit light beams 314 at various selected angles across a desired FoV. Unlike the mechanical system of FIG. 3A, the solid state system of FIG. 3B has essentially no moving parts. As before, a closed loop input system 315 can be used to control the scan rate, density, etc. of the output light 314. Other arrangements can be used as desired, including DLP (micromirror) technology, etc.

Regardless the configuration of the output system, FIG. 4 provides a generalized representation of a detector circuit 400 configured to process reflected light issued by the system of FIG. 2. The detector circuit 400 receives reflected pulses 402 which are processed by a suitable front end 404. The front end 404 can include optics, detector grids, amplifiers, mixers, and other suitable features to present input pulses reflected from the target. The particular configuration of the front end 404 is not germane to the present discussion, and so further details have not been included. It will be appreciated that multiple input detection channels can be utilized.

A low pass filter (LPF) 406 and an analog to digital converter (ADC) 408 can be used as desired to provide processing of the input pulses. A processing circuit 410 provides suitable signal processing operations to generate a useful output 412.

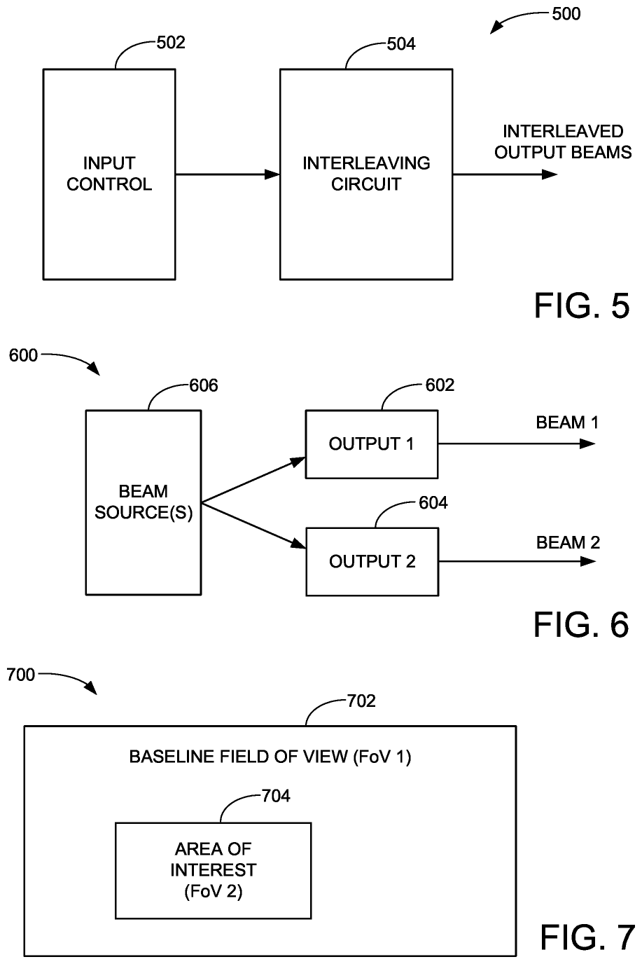

FIG. 5 shows an output circuit 500 that can be incorporated into the various emitter circuits discussed above in some embodiments. The output circuit 500 interleaves multiple output beams to provide variable scan patterns across the field of view (FoV) of the system to focus on areas of interest. The system includes an input control circuit 502, which determines suitable input signals for an interleaving circuit 504, which generates the interleaved output beams.

In some cases, multiple sources can be used to generate the interleaved output beams. These can be mechanical, solid-state, etc. as desired. In some embodiments, multiple rotatable polygons are provided that are utilized in conjunction to provide the interleaved output beams. While not necessarily limiting, the output systems can be arranged along orthogonal axes in comparison to one another. This provides 90 degrees of separation among the different scanning supplied by the system.

FIG. 6 shows one such multiple output system 600, with a first output device (output 1) 602 that outputs a first beam and a second output device (output 2) 604 that outputs a second beam that is interlaced with the first beam. Other arrangements can be used so this is merely for purposes of illustration and is not limiting. The respective output beams can be generated by a source 606. The source 606 can be a single beam source or multiple independently operated beam sources.

FIG. 7 generally depicts a scan response 700 to represent the detected output from a system such as in FIG. 6. While not limiting, the response can be used to generate a three-dimensional (3D) point cloud of the surrounding environment. The response 700 includes a baseline field of view (FoV 1) 702 which represents an overall scanning window generated by a first beam, such as the Beam 1 output from 602 in FIG. 6.

A smaller area of interest is denoted at 704. The area is within the larger baseline 702 and represents a portion thereof in which additional resolution is obtained using a second beam, such as the Beam 2 from output device 604 in FIG. 6. The area of interest 704 can also be referred to as a second field of view (FoV 2).

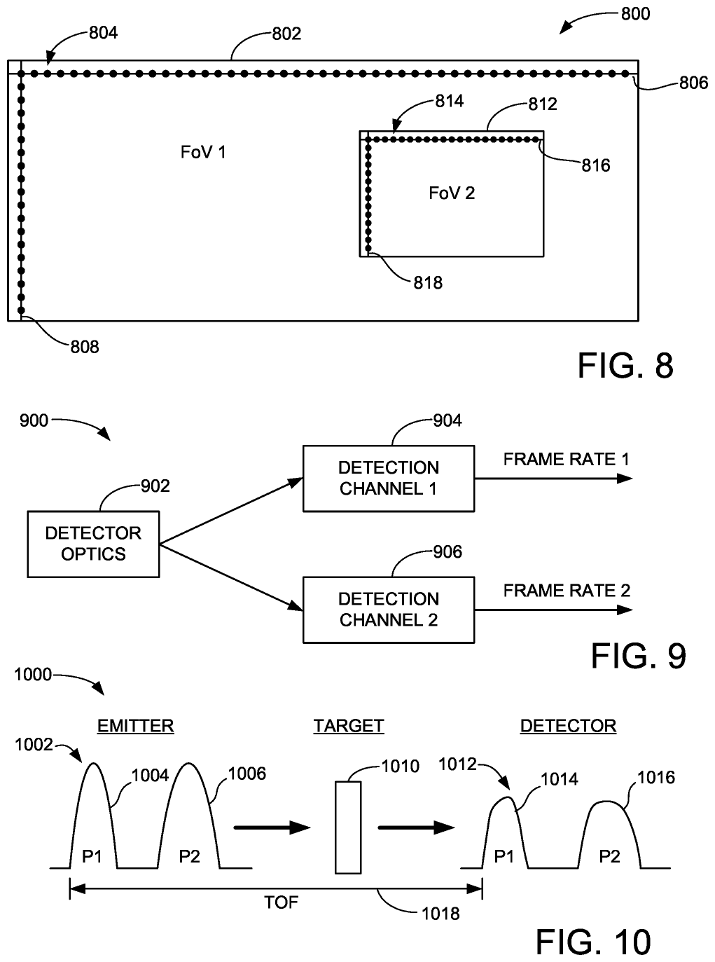

FIG. 8 shows another scan response 800 that can be obtained by the system 600 in accordance with some embodiments. A baseline field of view FoV 1 is generally denoted at 802, and represents a first area being scanned by the system at a baseline resolution. In this simplified example, beam pulses 804 are rasterized along rows 806 and columns 808 corresponding to respective x and y axes. Other scanning patterns and densities can be used. It will be noted that the actual numbers of rows and columns within FoV 1 may be significantly higher than those depicted in the simplified view of FIG. 8. In this example, it is contemplated that the pattern formed by pulses 804 correspond to Beam 1 from FIG. 6.

The rasterizing of the beam pulses 804 can be carried out in a number of ways. In one nonlimiting example, the beam pulses/points 804 are sequentially swept along each row 806 in a selected horizontal (x-axis) direction, such as from left to right. Once a given row has been swept, the next row 806 is swept, either from left to right as before or in an opposing direction (e.g., from right to left). In this way, the beam is stepwise swept across the entirety of the Fov 1 area. The positioning of the beams/points 804 is carried out by solid-state and/or mechanical means to precisely sweep the desired area. Once the area has been swept, the process repeats. Each sweeping of the area is referred to as a frame of data, and the rate at which each sweep takes place is referred to a frame rate. It will be understood that many frames are obtained per unit time.

A second field of view FoV 2 is denoted at 812 and represents an area of interest within the larger FoV 1. FoV 2 is subjected to additional scanning as indicated by beams 814 rasterized along x-y rows and columns 816, 818. The pattern formed by pulses 814 correspond to Beam 2 in FIG. 6.

It will be noted that the respective beam patterns will tend to be different, which may include the use of different beam sizes, powers, frequencies, wavelengths, densities, amplitudes, pulse counts, frame rates, and/or rasterizing patterns based on the respective operation of the different output systems 602, 604. While not limiting, it is contemplated that the respective beam patterns are interlaced, so that both beams 804 and 814 are respectively transmitted to the FoV 2 area. However, in other embodiments it is contemplated that only the beams 814 are supplied to the FoV 2 area and the rasterizing pattern with beams 804 “skips” the FoV 2 area and instead is limited to the area of FoV 1 outside FoV 2. Other alternatives are contemplated as well, including adjustments to the beams 804 in the area FoV 1 to increase or decrease the point density to achieve the desired enhanced density within FoV 2.

The FoV 2 area is selectively activated as discussed more fully below, and can take any selected size up to and including a single point up to substantially the entirety of the size of FoV 1. It is contemplated that steering mechanisms may be incorporated into the output 2 device 606 (FIG. 6) in order to selectively define and target the applicable area of interest within FoV 1.

While not limiting, the respective FoV 1 and FoV 2 areas may be scanned using orthogonal scanning patterns. For example, the FoV 1 area 802 may be rasterized by scanning horizontally (e.g., each row 806 may be scanned in turn followed by the scanning of a next row along the columns 808), and the FoV 2 area 812 may be rasterized by scanning vertically (e.g., each column 818 may be scanned in turn followed by the scanning of a next column along the rows 816).

FIG. 9 shows relevant aspects of a detection system 900 that can be used to detect and decode the interleaved scan patterns in FIG. 8. The system 900 can be incorporated into the various detectors discussed above. Detector optics 902 can include lenses, CCP devices, and/or other detection mechanisms to receive photons from targets within the FoV 1 and FoV 2 areas.

A single consolidated optics stage can be used, or multiple stages can be provided. In some cases, a first detection optics stage can be used to provide detection for the overall FoV 1 area, and a separate detection optics stage can be used to provide detection for the smaller FoV 2 area. Samples obtained from these respective stages can be omitted or forwarded as required. In some cases, samples from one beam scan, such as the beam/points 804 from the overall FoV 1 area can be incorporated into the FoV 2 processing of the beam/points 814, and vice versa, depending on timing, frame rate, location, etc.

The output from the optics 902 is respectively provided to separate detection channels 904, 906, which are denoted as detection channels 1 and 2. These channels are generally configured to process the respective FoV 1 and FoV 2 areas shown in FIG. 8. It is contemplated that the different detection channels will provide outputs at different frame rates, each frame corresponding to an entire rasterization (x-y) of the respective scanned areas, which will be repeated cyclically. Other waveform characteristics can be provided as well, such as different wavelengths, frequencies, pulse counts, amplitudes, etc. to distinguish between the respective beams 804, 814.

When differentiated pulses are supplied from a different FoV, weighting or other compensation can be supplied to the pulses to incorporate them into the final determination of the range information for the associated FoV. For example, if pulses 804 used to scan the entirety of the baseline FoV 1 area are received and processed into the second channel that processes the pulses 814 for FoV 2, gain adjustments, weighting or other factors can be applied to these pulses 804 in the second detection channel 806. The pulses 814 from FoV 2 can be processed in the first detection channel 804 using similar factoral adjustments to enable the pulses 814 to be processed along with the pulses 804.

FIG. 10 depicts a pulse transmission and reflection sequence 1000 carried out in accordance with various embodiments. An initial set of pulses is depicted at 1002 having two pulses 1004, 1006 denoted as P1 and P2. Each pulse may be provided with a different associated frequency or have other characteristics to enable differentiation by the system. The emitted pulses 1004, 1006 are quanta of electromagnetic energy that are transmitted downrange toward a target 1010.

Reflected from the target is a received set of pulses 1012 including pulses 1014 (pulse P1) and 1016 (pulse P2). The time of flight (TOF) value for pulse P1 is denoted at 1018. Similar TOF values are provided for each pulse in turn.

The received P1 pulse 1014 will likely undergo frequency doppler shifting and other distortions as compared to the emitted P1 pulse 1004. The same is generally true for each successive sets of transmitted and received pulses such as the P2 pulses 1006, 1016. Nevertheless, the frequencies, phase and amplitudes of the received pulses 1014, 1016 will be processed as described above to enable the detector channels to correctly match the respective pulses and obtain accurate distance and other range information.

In some cases, the emitted/received pulses such as P1 can represent the baseline pulses in the baseline field (e.g., FoV 1 in FIGS. 7-8), and the emitted/received pulses such as P2 can represent the higher resolution pulses in the area of interest (e.g., FoV 2 in FIGS. 7-8). As noted above, different frequencies, wavelengths, amplitudes, gain characteristics, pulse sequence counts, and other adjustments can be made to distinguish and process the respective pulses in the various areas.

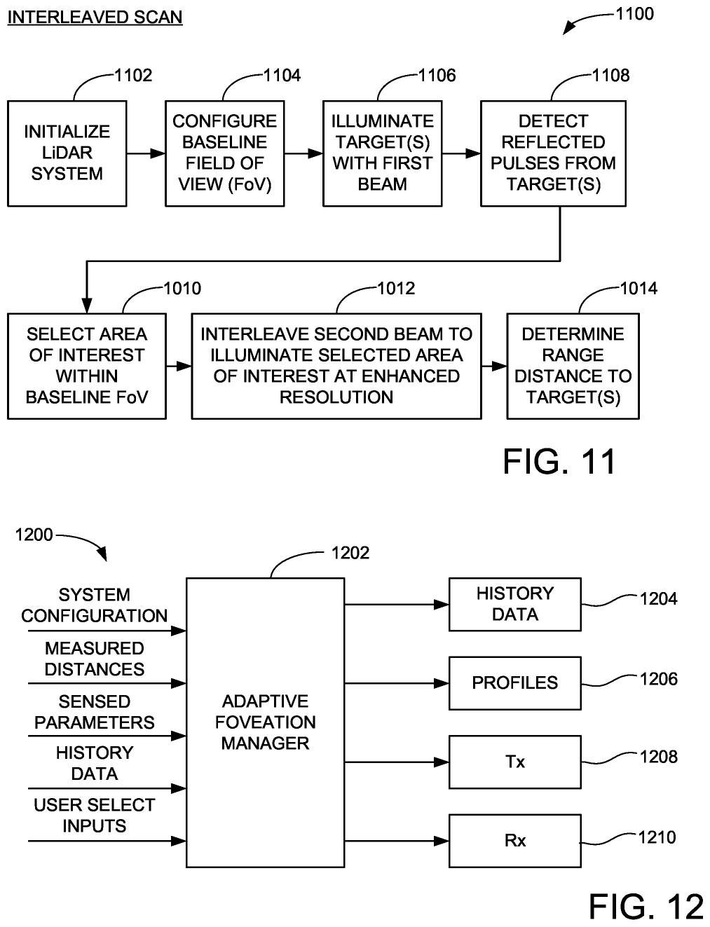

FIG. 11 is a sequence diagram 1100 for an interleaved scan operation carried out in accordance with various embodiments described herein. Other operational steps can be incorporated into the sequence as required, so the diagram is merely illustrative and is not limiting.

A LiDAR system such as 100 in FIG. 1 is initialized at block 1102. An initial, baseline field of view (FoV) is selected for processing at block 1104. This will include selection and implementation of various parameters (e.g., pulse width, wavelength, raster scan information, density, etc.) to accommodate the baseline FoV.

Thereafter the system commences with normal operation at block 1106. Light pulses are transmitted to illuminate various targets within the FoV as described above using the emitters as variously described in FIGS. 1-2 and 6-7. Reflected pulses from various targets within the baseline FoV are detected at block 1108 using a detector system as provided including at FIGS. 1 and 4; see also FIG. 10.

An area of interest within the baseline FoV is next selected at 1010. This can be carried out based on a number of inputs, including range information obtained from 1108, external sensor information, user input, etc. Regardless, a particular field of interest is identified to receive interleaved scanning. In response, a second beam is directed to the selected area of interest to provide enhanced resolution as described above. Range information for targets detected within the enhanced area is obtained during block 1014.

The system can cycle to provide different scanning patterns for different areas as required. In some cases, two separate output systems such as in FIG. 6 can be provided and both can be used to scan different portions of the baseline FoV. For example, Beam 1 can be used to scan the left-side of the baseline FoV and Beam 2 can be used to scan the right-side of the baseline FoV. Other divisions can be supplied as well; both beams can scan the entirety of the FoV, one beam can rasterize in one scan pattern while the other beam can rasterize in a different second pattern, etc. Regardless, the baseline FoV is provided with a first point density and a first corresponding resolution.

At such time that the area of interest is identified, which can include occurring as a result of the results of the previous scanning, the second beam can be directed to enhance scanning in the new area (FoV 2). The first beam can be maintained in a steady-state mode of operation to scan using the same pattern as before, or the first beam can be modified to account for the enhanced scanning in FoV 2 by the second beam.

In further embodiments, the second beam can be used to cyclically scan FoV 2 and then scan some portion of (or all of) the remaining FoV 1) in a repetitive manner. Further adjustments can be made to the system as a result of the detection of the range information from FoV 2, including further diversion of some or all of Beam 1 to this or another area.

While only a single area of interest is shown (e.g., FoV 2 in FIGS. 7-8), it will be appreciated that multiple areas of interest within the baseline FoV (FoV 1) can be concurrently scanned; for example, Beam 2 can be used to scan each of these areas in turn in a cyclical manner, or additional beams (e.g., a Beam 3, a Beam 4, etc.) can be switched in and/or diverted to process these additional areas.

FIG. 12 shows an adaptive foveation management system 1200 that can be incorporated into the system 100 of FIG. 1 in some embodiments. The system 1200 includes an adaptive foveation manager circuit 1202 which operates to implement the interleaved scans in the selected fields of interest within a baseline FoV as described above. The manager circuit 1202 can be incorporated into the controller 104 such as a firmware routine stored in the local memory 124 and executed by the controller processor 122.

The manager circuit 1202 uses a number of inputs including system configuration information, measured distance for various targets, various other sensed parameters from the system (including external sensors 126), history data accumulated during prior operation, and user selectable inputs. Other inputs can be used as desired.

The manager circuit 1202 uses these and other inputs to provide various outputs including accumulated history data 1204 and various profiles 1206, both of which can be stored in local memory such as 124 for future reference. The history data 1204 can be arranged as a data structure providing relevant history and system configuration information. The profiles 1206 can describe different pulse set configurations with different numbers of pulses at various frequencies and other configuration settings, as well as other appropriate gain levels, ranges and slopes for different sizes, types, distances and velocities of detected targets.

The manager circuit 1202 further operates to direct various control information to an emitter (transmitter Tx) 1208 and a detector (receiver Rx) 1210 to implement these respective profiles. It will be understood that the Tx and Rx 1208, 1210 correspond to the various emitters and detectors described above. Without limitation, the inputs to the Tx 1208 can alter the pulses being emitted in the area of interest (including actuation signals to selectively switch in the scanning of the FoV 2 area(s)), and the inputs to the Rx 1210 can include gain, timing and other information to equip the detector to properly decode the pulses from the enhanced resolution area of interest.

As described previously, different gain ranges can be selected and used for different targets within the same FoV. Closer targets within the point cloud can be provided with one range with a lower slope and magnitude values to obtain optimal resolution of the closer targets, while at the same time farther targets within the point cloud can be provided with one or more different gain ranges with higher slopes and/or different magnitude values to obtain optimal resolution of the farther targets.

It can now be understood that various embodiments provide a LiDAR system with the capability of emitting light pulses over a selected FoV, along with a specially configured foveation system that, when activated, interleaves additional scanning to a an area of interest within the FoV with a corresponding aspect of range. Any number of different alternatives will readily occur to the skilled artisan in view of the foregoing discussion.

In this way, the various embodiments cover methods to interlace scan patterns with the scanning architecture such that multiple frame rates can be used with constant increase or reduction in point resolution. This would also cover interlacing scan for systems with multiple laser beams to enable foveation. Also included are systems where two or more polygons (or other sources) are fully overlapped in FOV, where one may be used for full-frame scan, while the other can be used with variable span, variable velocity (down to zero) position control mode. Other arrangements are contemplated and will readily occur to the skilled artisan in view of the present disclosure.

While coherent, I/Q based systems have been contemplated as a basic environment in which various embodiments can be practiced, such are not necessarily required. Any number of different types of systems can be employed, including solid state, mechanical, DLP, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising:
an emitter of a LiDAR system configured to emit a first beam comprising light pulses at a first resolution to rasterize a baseline, first field of view (FoV); and
a controller circuit configured to, responsive to an activation signal, direct the emitter to concurrently emit a second beam comprising light pulses at a different, second resolution to rasterize a second FoV within the first FoV, the second beam interleaved with the first beam within the second FoV.

2. The apparatus of claim 1, wherein the emitter comprises a first beam source configured to generate the first beam and a second beam source configured to generate the second beam.

3. The apparatus of claim 2, wherein the second beam source is normally in a deactivated state and the controller circuit operates, responsive to the activation signal, to transition the second beam source from the deactivated state to an activated state to generate the second beam.

4. The apparatus of claim 2, wherein prior to the activation signal the second beam is directed to rasterize a first portion of the first FoV outside the second FoV and wherein responsive to the activation signal the second beam is moved so as to only rasterize the second FoV.

5. The apparatus of claim 1, wherein the activation signal is generated responsive to range information obtained using the first beam from the first FoV.

6. The apparatus of claim 1, wherein the activation signal is generated using an external sensor.

7. The apparatus of claim 1, wherein the light pulses in the first beam are provided with a first wavelength and the light pulses in the second beam are provided with a different, second wavelength.

8. The apparatus of claim 1, wherein each of the first and second beams are rasterized over the respective first and second FoVs in different orthogonal directions.

9. The apparatus of claim 1, further comprising an actuator that mechanically moves an optical element to direct the second beam to the second FoV.

10. The apparatus of claim 1, wherein each of the first and second beams are respectively directed using at least a selected one of a micromirror device, a solid-state array device, a galvanometer or a rotatable polygon.

11. The apparatus of claim 1, wherein a first portion of the light pulses of the first beam are directed to the second FoV and a remaining second portion of the light pulses of the first beam are directed to the first FoV outside the second FoV at a reduced density.

12. The apparatus of claim 1, wherein the light pulses are rasterized along orthogonal x-y axes in rows and columns in both the first FoV and the second FoV.

13. The apparatus of claim 1, wherein a size and location of the second FoV are selected based on range information obtained using a detector that detects reflected pulses from the first FoV.

14. The apparatus of claim 1, wherein the pulses in the first beam have a first set of waveform characteristics and are processed by a first detection channel of a detector at a first frame rate, and the pulses in the second beam have a different, second set of waveform characteristics that are processed by a different, second detection channel at a different second frame rate.

15. A method, comprising:
using an emitter of a LiDAR system to emit a first beam comprising light pulses at a first resolution and a first frame rate over a baseline, first field of view (FoV);
receiving an activation signal; and
interleaving the first beam with a second beam comprising light pulses at a higher, second resolution and a higher, second frame rate over a smaller second FoV within the first FoV responsive to the activation signal.

16. The method of claim 15, wherein the first beam is rasterized along a first axial direction and the second beam is rasterized along a second axial direction orthogonal to the first axial direction.

17. The method of claim 15, further comprising providing the respective pulses in the first and second beams with different waveform characteristics and using the different waveform characteristics to process reflected pulses from the first beam in a first detection channel and reflected pulses from the second beam in a different, second detection channel.

18. The method of claim 15, further comprising decoding range information from a target in the first FoV and generating the activation signal responsive to the decoded range information.

19. The method of claim 15, further comprising using at least a selected one of a rotatable mirrored polygon, a solid state array integrated circuit device, or a DLP micromirror device to direct each of the respective first and second beams through at least one optical element.

20. The method of claim 13, wherein the first beam is generated by a first laser source at a first nominal wavelength and the second beam is generated by a different, second laser source at a different, second nominal wavelength.
